(19) United States
(12) Patent Application Publication
(10) Pub. No.: US 2026/0035180 A1
(43) Pub. Date: Feb. 5, 2026

(54) SINGULATION-CONTROLLED AUTOMATED SORTATION SYSTEM AND METHOD

(71) Applicant: Aegis Sortation, LLC, Louisville, KY (US)

(72) Inventors: Dean TERRELL, Louisville, KY (US); Ken ICE, Louisville, KY (US); Cameron HICKS, Louisville, KY (US); Derek STURM, Louisville, KY (US)

(73) Assignee: Aegis Sortation, LLC, Louisville, KY (US)

(21) Appl. No.: 19/357,858

(22) Filed: Oct. 14, 2025

Related U.S. Application Data
(63) Continuation-in-part of application No. 19/067,537, filed on Feb. 28, 2025.
(60) Provisional application No. 63/559,148, filed on Feb. 28, 2024.

(51) Int. Cl. B65G 13/10; B07C 3/08

(52) U.S. Cl. CPC B65G 13/10; B07C 3/08; B65G 2201/0285; B65G 2203/0216; B65G 2203/0233; B65G 2203/025

(57) ABSTRACT

An automated sortation system includes infeed and outfeed conveyors, a singulator including an array of a plurality of independently-addressable rollers, a monitor system, and a control system. Based on input from one or more sensors of the monitor system and/or status information of one or more of the conveyors and rollers, real-time parcel status data is generated of parcels conveyed within the system; the plurality of parcels are prioritized within a priority queue based on the real-time parcel status data; trajectories are generated for the parcels; and the rollers are dynamically controlled to form dynamically changing conveyance vector fields. A cycle including real-time sensing and tracking, generating and updating parcel status data, generating and updating the priority queue, determining and updating the parcel trajectories, and dynamically controlling the singulator is repeated with data from various operations being fed back to inform and update other operations.

### CROSS-REFERENCE TO RELATED APPLICATIONS

This application is a continuation-in-part of U.S. application Ser. No. 19/067,537, filed Feb. 28, 2025, which claims the benefit of U.S. Provisional Application 63/559,148, filed Feb. 28, 2024, the entire disclosures of which and all attachments thereto are incorporated herein by reference in their entireties.

### BACKGROUND

### 1. Field

Example embodiments described herein relate to the field of conveyors and conveyor operation, and more particularly sortation conveyor systems in which the conveyance of parcels and other goods can be directed. One or more example embodiments described herein may provide systems, devices and methods allowing parcels and other goods to be conveyed and directed individually or in groups for further processing, conveying, and/or tracking.

### 2. Background

Sortation is the process of identifying parcels and other goods on a conveyor system and diverting them to a specific destination. Sortation in the order fulfillment, warehousing, materials handling, and ecommerce industries has come a long way from a time when industries had few options outside of manual sorting. Today, there are a multitude of automated solutions that can boost efficiency and accuracy and reduce costs. Sortation equipment includes various types of sorters and conveyors including, but not limited to belt sorters, pop-up wheel/roller/belt sorters, pusher sorters, paddle sorters, tilt tray sorters, narrow belt sorters, and sliding shoe sorters.

Some related art sortation systems implement rollers that can be positioned along a path and can be controlled to convey or change the path of an item. Such devices are described, for example in U.S. Patents Nos: 5,921,374; 2,874,818; and 2,613,790, the disclosures of which are incorporated herein by reference in their entireties.

### SUMMARY

Example embodiments may address at least the above such drawbacks and/or disadvantages and other disadvantages not described above. Also example embodiments are not required to overcome the disadvantages described above, and may not overcome any of the problems described above.

According to an implementation of an example embodiment, an automated singulation method of a system comprising infeed and outfeed conveyors, a singulator including an array of a plurality of independently-addressable conveying elements, such as, for example, rollers, a monitor system, and a control system, may comprise: based on input from one or more sensors of the monitor system and/or status information of one or more of the conveyors and rollers, real-time parcel status data is generated of parcels conveyed within the system; the plurality of parcels are prioritized within a priority queue based on the real-time parcel status data; trajectories are generated for the parcels; and the rollers are dynamically controlled to form dynamically changing conveyance vector fields. A cycle including real-time sensing and tracking, generating and updating parcel status data, generating and updating the priority queue, determining and updating the parcel trajectories, and dynamically controlling the singulator is repeated with data from various operations being fed back to inform and update other operations.

According to an implementation of an example embodiment, an automated singulation method of a system comprising a monitor system, comprising at least one sensor, and a singulator comprising an array of a plurality of independently-addressable rollers; may comprise: the at least one sensor sensing real-time information of each of a plurality of parcels within the sortation system; generating real-time parcel status data comprising, for each of the plurality of parcels, a parcel identification and status information; ordering a priority queue in which each of the plurality of parcels is assigned a relative priority, based on the real-time parcel status data; for each of the plurality of parcels, determining a parcel trajectory based on the real-time parcel status data and the priority queue; and dynamically controlling the independently-addressable rollers of the singulator to form dynamically changing conveyance vector fields thereby enabling the independently-addressable rollers to guide each of the plurality of parcels along a correspondingly-generated parcel trajectory; wherein: the method comprises performing the sensing, generating, ordering, determining, and dynamically controlling in a repeated plurality of cycles.

According to an example implementation, in a given cycle of the plurality of cycles, the real-time parcel status data may be generated based on the real-time information of each of the plurality of parcels, the priority queue ordered in a cycle prior to the given cycle, and one or more of the parcel trajectories determined in a cycle prior to the given cycle.

According to an example implementation, the generating the real-time parcel status data may comprise determining a parcel velocity for each of the plurality of parcels, wherein the determining the parcel velocity may comprise: determining that a trajectory-predicted velocity is the parcel velocity when a trajectory is determined for the parcel and a sensed location of the parcel is the same as a trajectory-predicted location of the parcel; determining the parcel velocity based on the sensed location of the parcel and status information of rollers corresponding to the sensed location of the parcel when a trajectory is determined for the parcel and the sensed location of the parcel is not the same as the trajectory-predicted location of the parcel; and determining the parcel velocity based a change in the sensed location of the parcel over time when there is no trajectory determined for the parcel and the sensed position of the parcel is valid.

### BRIEF DESCRIPTION OF THE DRAWINGS

The above and other objects, advantages, and salient features will become apparent to those skilled in the art from the following detailed description of example embodiments when taken in conjunction with the accompanying drawings in which:

FIG. 1 is a perspective illustration of a puck including a belt drive according to an example embodiment;

FIGS. 2A and 2B are a perspective illustration and a top view, respectively, of a puck including a poly drive according to an example embodiment;

FIG. 3A is a perspective illustration of an example puck including a swivel drive according to an example embodiment;

FIG. 3B is a perspective illustration of another example puck including a swivel drive according to an example embodiment;

FIGS. 4A and 4B illustrate different arrangements of a plurality of pucks according to example embodiments;

FIG. 5 is a perspective view of an addressable roller module according to an example embodiment;

FIG. 6A is a diagram of a conveyance vector field formed by an addressable roller module according to one or more example embodiments;

FIGS. 6B-6I are schematic diagrams of example vector fields formed by an addressable roller module according to one or more example embodiments;

FIG. 7 is a diagram of a sortation system including an addressable roller module according to an example embodiment;

FIGS. 8A-8C are perspective illustrations of different arrangements of multiple addressable roller modules according to one or more example embodiments;

FIG. 9 is a diagram of a sortation system according to another example embodiment;

FIG. 10 is a diagram the sortation system of FIG. 9 illustrating additional elements of the example control system according to an example embodiment;

FIG. 11 is a flow diagram of a singulator control cycle according to one or more example embodiments;

FIG. 12 illustrates a flow of example singulator control operations according to one or more example embodiments;

FIG. 13 illustrates a flow of example operations according to one or more example embodiments; and

FIG. 14 is an example schematic illustration of a singulator according to one or more example embodiments.

### DETAILED DESCRIPTION

Reference will now be made in detail to example embodiments which are illustrated in the accompanying drawings, wherein like reference numerals refer to like elements throughout. In this regard, the example embodiments may have different forms and may not be construed as being limited to the descriptions set forth herein.

It will be understood that the terms “include,” “including”, “comprise, and/or “comprising,” when used in this specification, specify the presence of stated features, integers, steps, operations, elements, and/or components, but do not preclude the presence or addition of one or more other features, integers, steps, operations, elements, components, and/or groups thereof.

It will be further understood that, although the terms “first,” “second,” “third,” and/or other, may be used herein to describe various elements, components, regions, layers and/or sections, these elements, components, regions, layers and/or sections may not be limited by these terms. These terms are only used to distinguish one element, component, region, layer or section from another element, component, region, layer or section.

As used herein, the term “and/or” includes any and all combinations of one or more of the associated listed items. Expressions such as “at least one of,” when preceding a list of elements, modify the entire list of elements and do not modify the individual elements of the list.

Expressions of relational orientation, such as “upper,” “lower,” “inside,” “outside,” and/or other expressions, which are used for explaining the structural positions of various components as described herein, are not absolute but relative. The orientation expressions are appropriate when the various components are arranged as shown in the figures, but should change accordingly when the positions of the various components in the figures change.

Various terms and expressions, such as, but not limited to: “module,” poly,” “swivel,” “roller,” “puck,” belt,” “diverter,” “sorter,” “park and go,” are used to refer to particular system components. Different companies may refer to a component by different names—this document does not intend to distinguish between components that differ in name but not function.

Matters of these example embodiments that are obvious to those of ordinary skill in the technical field to which these example embodiments pertain may not be described here in detail.

One or more example embodiments described herein may improve upon various capabilities of related art sorting and discharging systems and methodologies, for example and without limitation, by providing individual features and methodologies, and various combinations thereof, that can facilitate improved flexibility and control for directing conveyance of parcels/items/goods.

One or more example embodiments described herein may provide system and method for automated sortation, conveying, and/or diverting that can accumulate a set number of parcels and then transfer the accumulated set number of parcels for further processing and/or conveying.

One or more example embodiments described herein may provide a conveyance system comprising a plurality of proximately positioned conveying components that can be individually controlled to facilitate more precise conveyance of various size parcels/items/goods in one or more desired directions, and in example implementations, at one or more desired speeds.

One or more example embodiments described herein may provide a conveyance system and methodology including, for example and without limitation, a plurality of conveying components each containing a motor allowing for computerized individual control of conveyance speed for each conveying component. Each such conveying component may be descriptively called, without implying any limitations, a “puck.” In an example implementation, each puck can contain one or more active rollers configured to selectively contact one or more parcels/items/goods to be conveyed and, for example, a Motor Driven Live Roller (MDR) motor to drive at least one or more of the active rollers.

One or more example embodiments described herein may provide individual rotation for each puck where, for example, each puck can contain a rotational motor to manipulate the direction of conveyance, or flow, of parcels/items/goods allowing for individual rotational control of each puck and also selective grouped control of the pucks depending on preferred flexibility for controlling flow of parcels/items/goods (for example: fine control for singulation of parcels/items/goods).

One or more example embodiments described herein may provide systems and methodologies that facilitate parcels/items/goods tracking throughout system by configuring sensors (for example, photoelectronics) to track the leading and trailing edge of individual parcels/items/goods coming in contact with conveying components, for example to ensure proper diverting.

One or more example embodiments described herein may provide systems and methodologies comprising parcels/items/goods singulation and/or gapping prior to diverting of parcels/items/goods, wherein parcels/items/goods can proceed to conveying components for example in a single file line, with a gap therebetween, for example to further ensures proper diverting of parcels/items/goods.

One or more example embodiments described herein may provide systems and methodologies comprising sensors at each divert location to confirm successful diverting or parcels/items/goods.

One or more example embodiments described herein may provide systems and methodologies comprising one or more conveying components configured to convey parcels/items/good in any direction, wherein modules, such as pucks, can rotate clockwise or counterclockwise up to 90 degrees whereby modules can convey parcels/items/goods in either direction, which can facilitate conveyance opportunity in a full 360 range.

One or more example embodiments described herein may provide systems and methodologies that can function as a reversible system, where, for example and without limitation: in one operation, the system can be used to divert parcels off of a main conveyor onto one or more exit conveyors; and in another operation, the system can receive parcels from one or more exit conveyors and transport them to a main conveyor whereby the system can merge parcels/items/goods into the system dynamically.

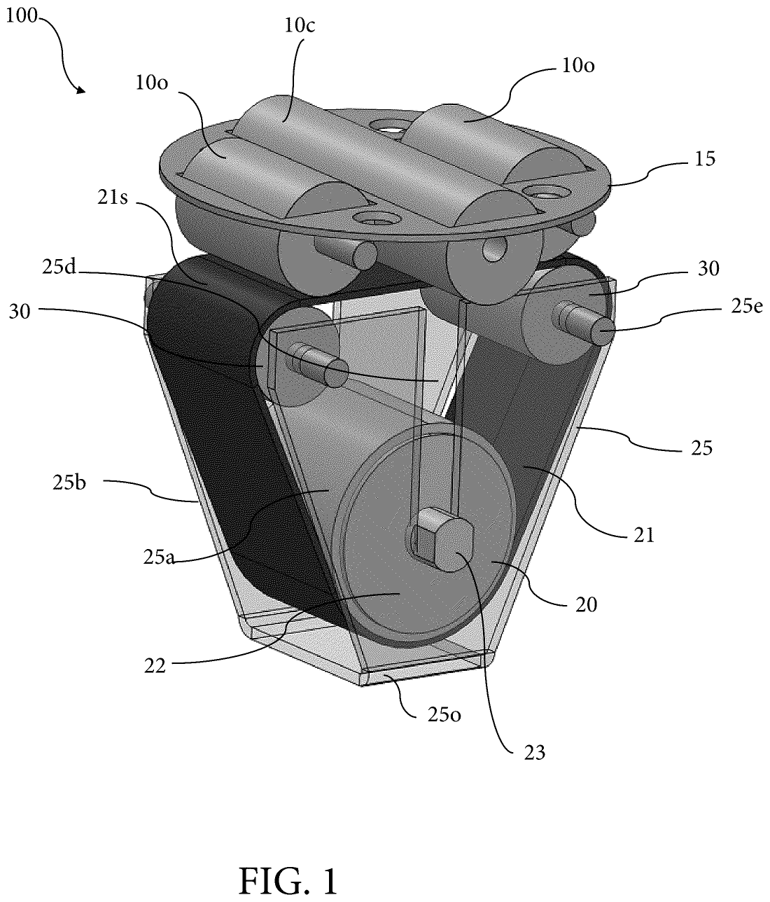

### Puck—FIG. 1

FIG. 1 is a perspective illustration of a puck including a belt drive according to an example embodiment. The puck 100 includes a plate 15 supporting a plurality of convey rollers 10, and a frame 25 supporting a driving motor 20. A belt 21, driven by the driving motor 20 drives the convey rollers 10. The frame 25 supports the driving motor 20 which may be embodied as a roller 22 on an axle 23. As shown in the example embodiment of FIG. 1, the frame comprises substantially parallel sides 25a, 25b, and a base 25c. The axle 23 of the driving motor is supported between the sides 25a, 25b of the frame 25 and may be fixed to the sides 25a, 25b, and the roller 22 may rotate with respect to its axle 23. Alternately, the axle 23 may be rotatably supported by the frame 25. For example, the axle 23 may be rotatably supported in corresponding holes, slots 25d, or divots in the opposite sides 25a, 25b of the frame 25, as shown in FIG. 1. Two or more additional rollers 30 may also be supported by the frame, positioned above the driving motor 20. The additional rollers 30 may be free to rotate as driven by the belt 21, secured therearound and driven by the driving motor 20. The axles of the additional rollers 30 may be fixed between the sides 25a, 25b of the frame 25 while the additional rollers 30 rotate with respect to their axles, or the axles may be rotatably supported by the frame 25, as, for example, within corresponding slots, holes 25e, or divots in the sides 25a, 25b of the frame 25. The belt 21 is secured around the rollers 30, forming a surface 21s configured to contact and drive the convey rollers 10. Any one or more of the rollers described herein may be substantially cylindrical, as shown, or may be rollers or any other type of wheel as would be understood by one of skill in the art. The drive motor 20 may comprise a 24 Volt (V) direct current (DC) motor, or another motor as would be understood by one of skill in the art.

According to example implementations of one or more example embodiments described herein, a plate 15 can be configured to support the axles of each of a plurality of convey rollers 10 and may have a substantially circular outer circumference, as shown. As shown in FIG. 1, the plate 15 may support the axles of a central convey roller 251c and a pair of outer convey rollers 210. The axles may be supported by means of bolts extending downward from the plate 15 at the ends of each of the axles or by another mechanical connection. The axles of the convey rollers may be fixed to the plate 15, and the convey rollers 10 may rotate with respect to their respective axles, or, the axles may be rotatably supported by the plate 15. As shown in FIG. 1, the central convey roller 10c may be longer than each of the outer convey rollers 100, which may be of equal length, but this is merely an example, and the respective numbers, lengths, and sizes of the convey rollers may vary for this example as would be understood by one of skill in the art. The plate 15 is secured to the frame 25 such that the belt 21 is held against the undersides of the convey rollers 10. Any one or more of the rollers described herein may be substantially cylindrical, as shown, or may be rollers or any other type of wheel as would be understood by one of skill in the art.

The drive motor may be operationally coupled, via a wired or wireless connection, to a controller thus enabling the direction, speed (rotations per minute (rpm)), and power of the motor to be independently controlled, thereby enabling each of the speed, direction, and power of the one or more convey rollers of the puck to be independently controlled.

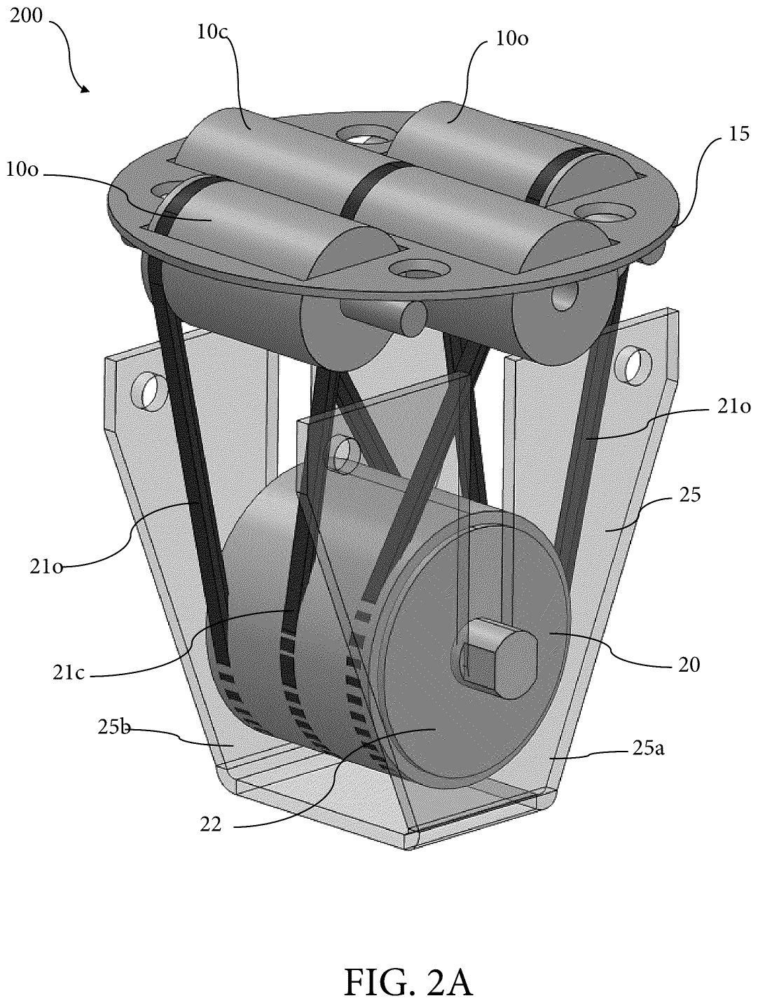

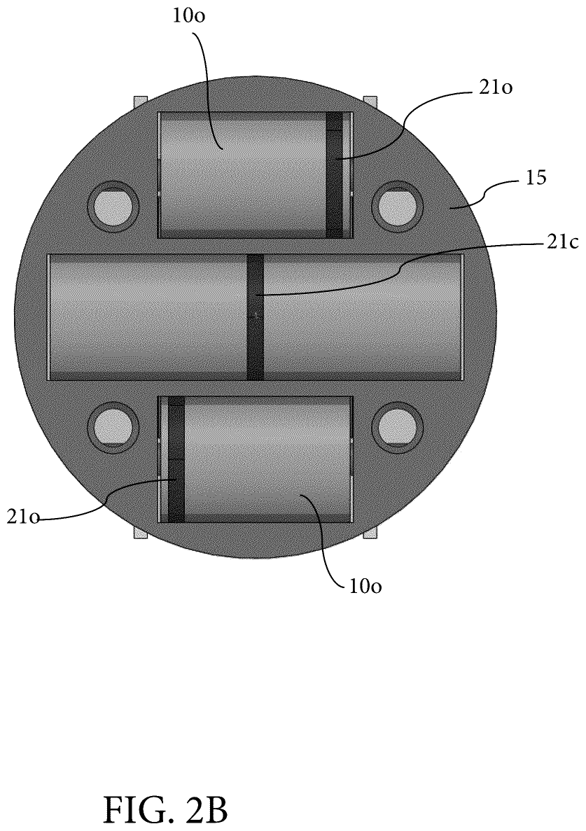

### Puck—FIGS. 2A-2B

FIGS. 2A and 2B are a perspective illustration and a top view, respectively, of a puck including a poly drive according to an example embodiment. According to an implementation of example embodiments described herein, the puck 200 may include a plate 15 supporting a plurality of convey rollers 10, and a frame 15 supporting a driving motor 20. The plate 15, convey rollers 10, frame 15, and driving motor 20 may be analogous to those described with respect to the example embodiment of FIG. 1. Distinct from the example embodiment of FIG. 1, the puck 200 of this example embodiment includes a plurality of belts 21. As shown in FIG. 2A, the puck 200 may include a plurality of belts 21 corresponding to the plurality of convey rollers 10: a central belt 21c around a roller 22 of the driving motor 20 and the central convey roller 10c; and a pair of outer belts 210, respectively secured around the roller 22 of the driving motor 20 and the respective ones of the pair of outer rollers 100. One or more additional belts may be secured around the roller 22 of the driving motor 20 and any one of the convey rollers 10, as would be understood by one of skill in the art. The central belt 21c is shown as secured around a central region of the roller 22 and a central region of the central convey roller 10c, and the outer belts 210 are shown as secured around opposite ends of the roller 22 and opposite ends of the pair of outer convey rollers 100; however, this is merely an example arrangement, and the belts 210 may be secured to the roller 22 and the convey rollers 100 in any of various arrangements and positions as would be understood by one of skill in the art.

As with the example embodiment of FIG. 1, the drive motor of the example embodiment of FIGS. 2A and 2B may be operationally coupled, via a wired or wireless connection, to a controller thus enabling the direction, speed (rpm), and power of the motor to be independently controlled, thereby enabling each of the speed (rpm), direction, and power of the one or more convey rollers of the puck to be independently controlled.

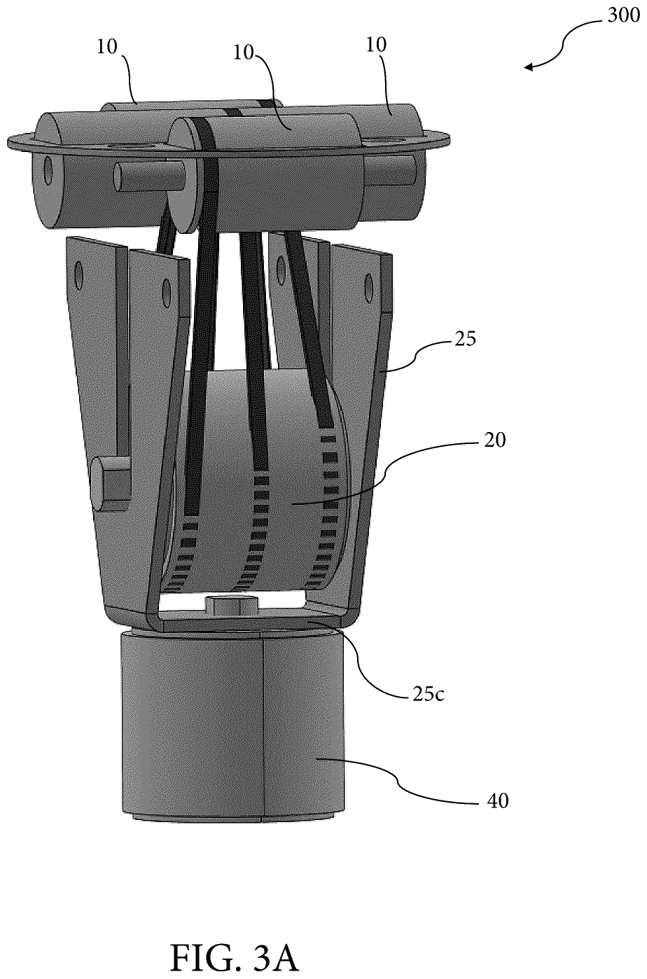

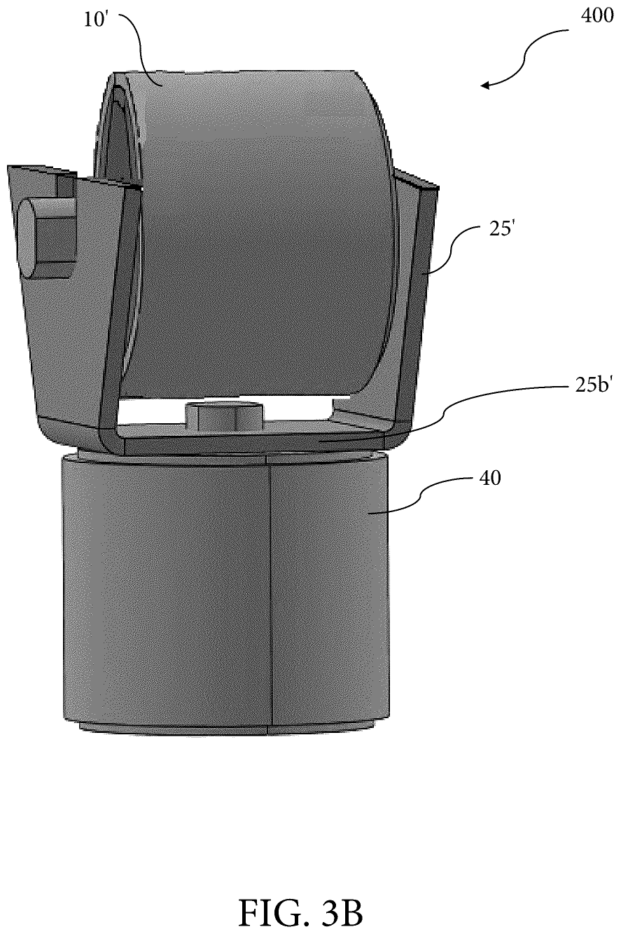

### Puck—FIGS. 3A and 3B

FIG. 3A is a perspective illustration of an example puck including a swivel drive according to an example embodiment. According to an implementation of example embodiments described herein, the puck 300 may include a plate 15 and convey rollers 10 connected, via one or more belts 21 to a driving motor 20 held by a frame 25. The plate 5, convey rollers 10, one or more belts 21, driving motor 20, and frame 25 of the puck 300 of this example embodiment may be analogous or equivalent to those of the example examples embodiments of FIG. 1 or FIGS. 2A and 2B, or may be any of various other puck elements, as would be understood by one of skill in the art. According to this example embodiment, the puck 300 further includes a swivel motor 40. The swivel motor 40 is pivotably connected to the frame 25 and operates to control a pivot direction of the frame 25 around an axis AA normal to a surface S of the plate 15. As with the example motor rotors discussed with respect to the above embodiments, the swivel motor is connected to a power source and operationally connected to a controller (not shown) to thereby receive a signal enabling the swivel motor to be independently controllable. The swivel motor 40 may comprise a 24 Volt (V) direct current (DC) motor, or another motor as would be understood by one of skill in the art.

As with the example embodiments described above, the drive motor of the example embodiment of FIG. 3A may be operationally coupled, via a wired or wireless connection, to a controller thus enabling the direction, speed (rpm), and power of the motor to be independently controlled, thereby enabling each of the speed (rpm), direction, and power of the one or more convey rollers of the puck to be independently controlled. Likewise, the swivel motor may be operationally coupled, via a wired or wireless connection, to a controller thus enabling the direction, speed (rpm), and power of the motor to be independently controlled, thereby enabling each of the speed (rpm of rotation of the frame, e.g.), direction, and power of the rotation of the frame to be independently controlled.

FIG. 3B is a perspective illustration of another example puck including a swivel drive according to an example embodiment. According to an implementation of example embodiments described herein, the puck 400 may include a frame 25′ and a convey roller 10′ which is both a convey roller and a motor. The convey roller 10′ is rotatably supported by the frame 25, and may incorporate a motor functioning as a drive motor which directly drives rotation of the convey roller 10′. Thus, the convey roller 10′ may comprise a 24 Volt (V) direct current (DC) motor, or another motor as would be understood by one of skill in the art.

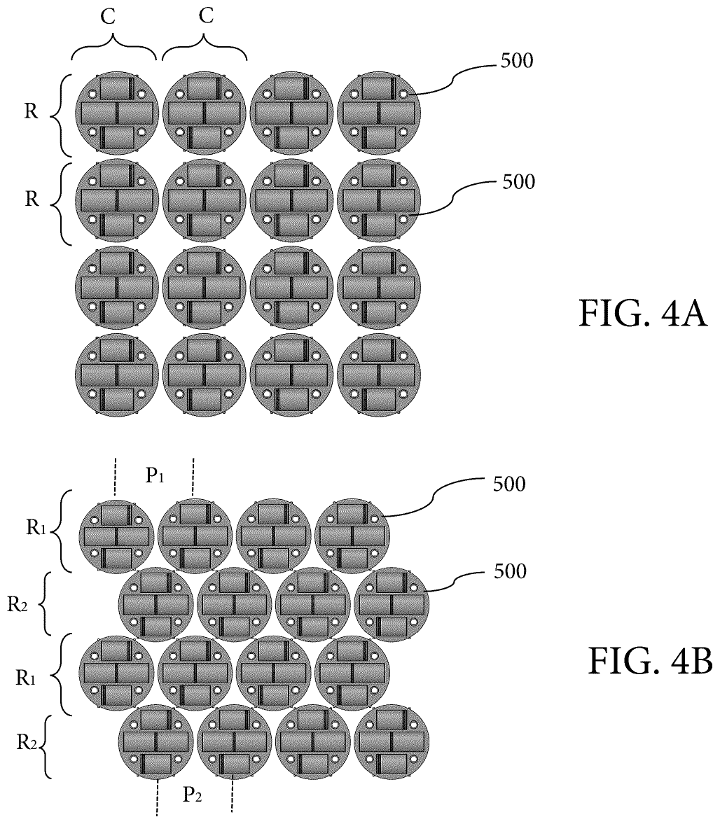

### Example Puck Arrangements—FIGS. 4A-4C

FIGS. 4A and 4B illustrate different arrangements of a plurality of pucks according to example embodiments. According to an implementation of example embodiments described herein, the pucks 500 in these arrangements may be any of those 100, 200, or 300 described with respect to the example embodiments of FIGS. 1 and 2A-2C or may be modified from the examples of FIGS. 1 and 2A-2C. As shown in FIG. 4A, a plurality of pucks 500 may be disposed in a traditional layout comprising a plurality of rows R and columns C in which the pucks in each row R are aligned with the pucks in each other row R, thus forming aligned columns C. As shown in FIG. 4B, a plurality of pucks 500 may be disposed in a staggered layout comprising a first plurality of rows R1, including pucks spaced by a pitch P1, alternating with a plurality of second rows R2, including pucks spaced by a pitch P2. As shown in the example of FIG. 4B, the pitch P1 may be the same as the pitch P2, and the plurality of second rows R2 are offset by ½ P, such that centers of the pucks of second, offset, rows R2 are disposed midway between the centers of the pucks of the first rows R1. The staggered layout of FIG. 4B allows the rows R to be nestled closer together than the rows of the traditional layout shown in FIG. 4A. The staggered layout of FIG. 4B is merely an example, and the pucks may be arranged in any of various other staggered layouts, as would be understood by one of skill in the art.

The dimensions of the pucks according to the example embodiments described with respect to any of FIGS. 1, 2A-2C, 3, 4A, and 4B may be determined by one of skill in the art. For example, each puck 100 or 200 may have an outer diameter of 4 inches (in.) or less, or an outer diameter of 3 in. or less, and in the example arrangements of FIGS. 4A and 4B, the pucks 100 or 200 may be spaced at a pitch of 4 in. by 4 in. in the traditional layout or a pitch of 4 in. by 3.5 in. in a staggered layout. As shown in the example arrangement of FIG. 4C.

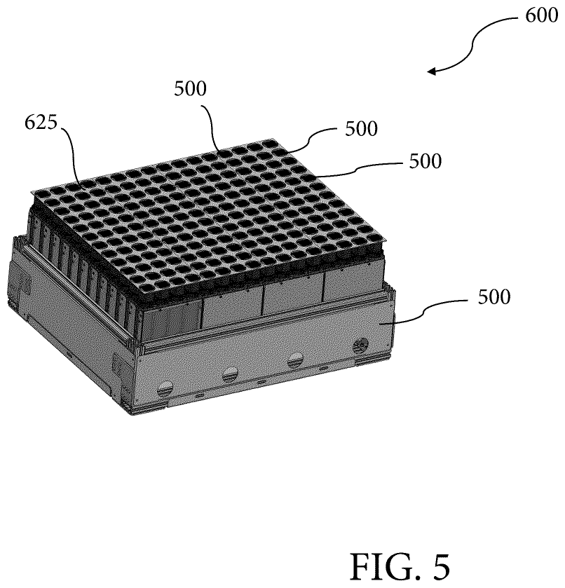

### Module—FIG. 5

FIG. 5 is a perspective view of an addressable roller module 600 according to an example embodiment. According to an implementation of example embodiments described herein, and as shown in FIG. 5, a module 600 may include an array of a plurality of pucks 500, mounted within a module frame 625 also holding therewithin guarding and wiring (not shown). Each of the plurality of pucks 500 may be a puck according to one of the example embodiments described herein, or may be modified therefrom as would be understood by one of skill in the art. The pucks 500 in the module 600 may be arranged in one of a traditional layout or a staggered layout as described herein, or in another, modified layout, such as an irregular layout, as would be understood by one of skill in the art. According to this example embodiment, each puck 500 comprises at least one convey roller protruding from a top surface SS of the module 600 and rotatable about its axel which is held substantially parallel to the top surface SS. Each puck 500 also includes a drive motor which drives the at least one convey roller, and a swivel motor which drives a rotation (swivel) of the convey roller about a swivel axis normal to the top surface SS. Each of the drive motor and the swivel motor may be a 48 V DC motor, and each of the drive and swivel motors is independently addressable and controllable via a wired or wireless connection to a controller, as discussed above with respect to the example embodiments of FIGS. 1, 2A and 2B, and 3. Accordingly, each of the speed (rpm), direction, and power of each convey roller of each of the plurality of pucks 500 of the module 600 is independently controllable via the drive motor of the corresponding puck operationally connected to and independently controlled by a controller. Likewise, each of the speed (e.g. rpm of the rotation of the frame), direction, and power of the rotation of the frame of each of the plurality of pucks 500 and thus of the corresponding convey roller(s) thereof, of the module 600 is independently controllable via the swivel motor of the corresponding puck operationally connected to and independently controlled by a controller.

According to one or more example embodiments, in view of the independent addressability and controllability of each motor of each puck, a single convey roller can change speed and direction of conveyance and can rotate clockwise or counter clockwise, for example, through 90 degrees, 180 degrees, or even 360 degrees. The result is that a module can convey in any direction.

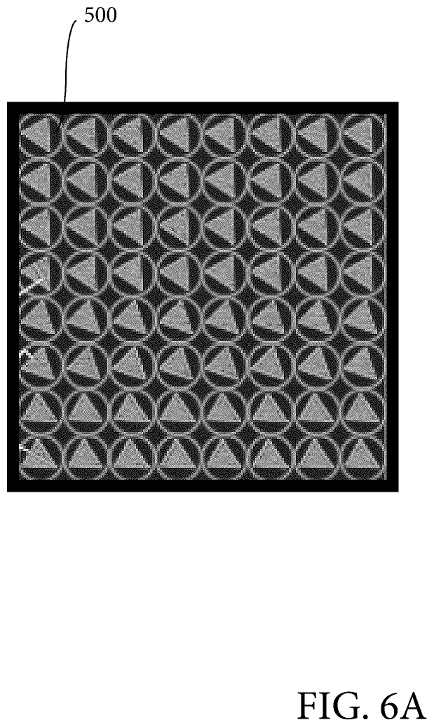

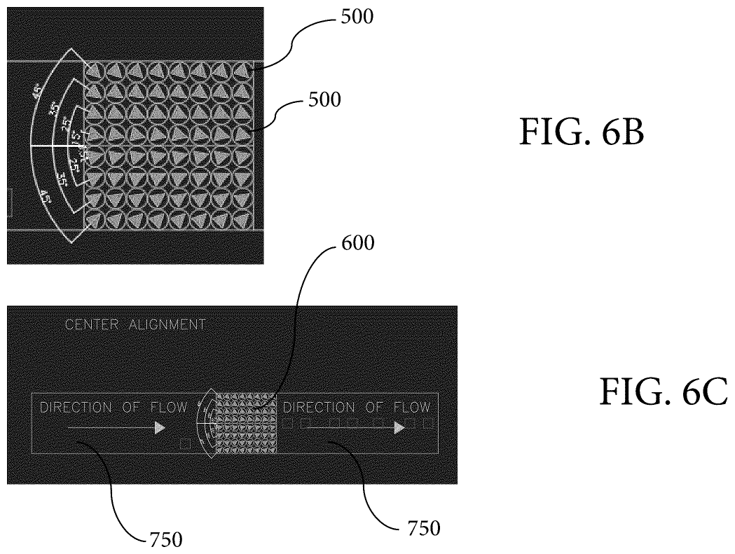

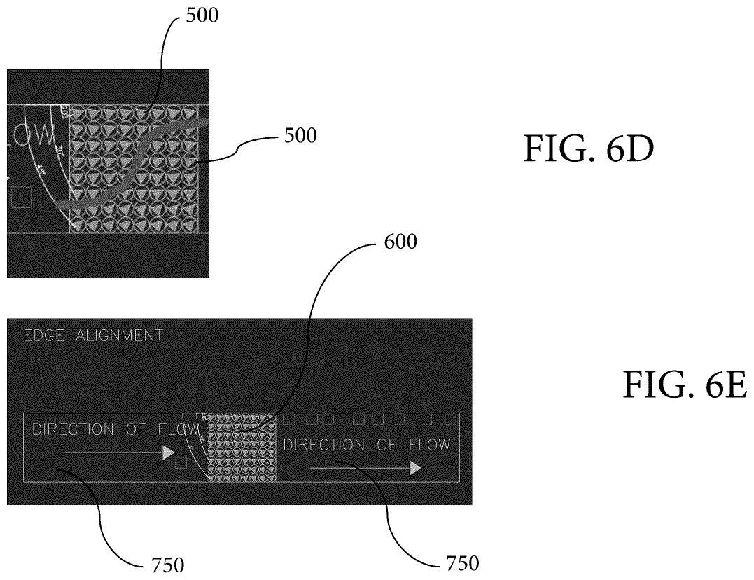

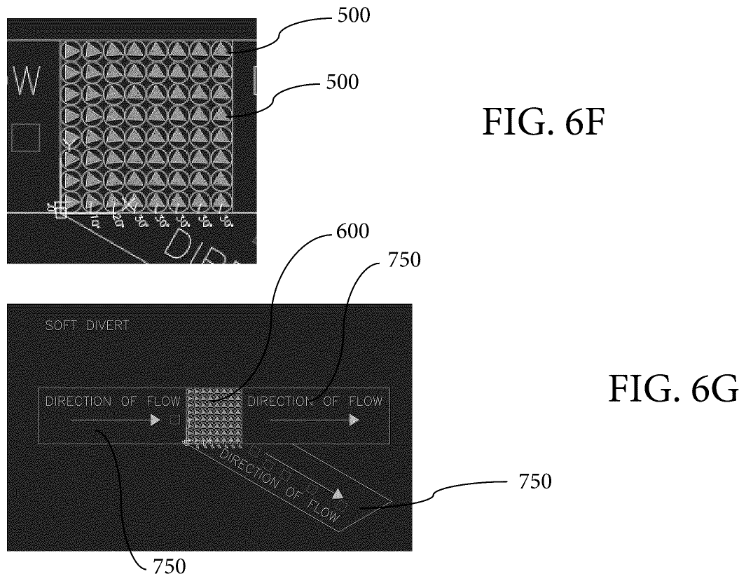

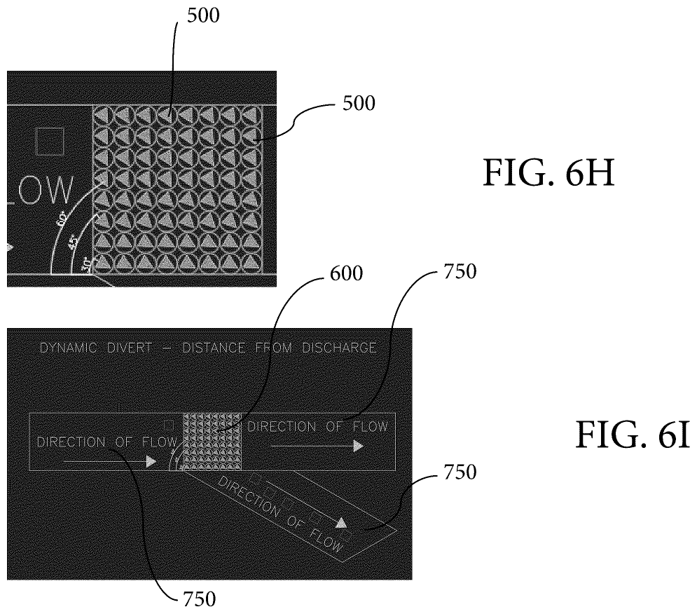

Due to the independent controllability of the speed, direction and power of both the convey roller and the swivel of the convey roller of each puck in an addressable roller module, the surface of a single addressable roller module or a surface formed by an array of a plurality of addressable roller modules may be controllable to convey one or more items on a dynamically changeable path. In other words, for example, the surface formed by the array may be controllable into a first configuration to convey one or more items, for example in a first direction or manner, and may then be controllable into a second configuration, different from the first configuration, to convey the same or different one or more items in a second, different, direction or manner. The field formed by an array of a plurality of pucks of one or more addressable roller modules will be referred to herein as a conveyance vector field, and, as described herein, the conveyance vector field may be changed among any of various different conveyance vector fields. FIG. 6A is a diagram of a conveyance vector field formed by one example addressable roller module 600 according to one or more example embodiments. As illustrated in FIG. 5, each puck 500 is shown with a representative arrow therein indicating the direction of flow resulting from the combination of the orientation (swivel) and the direction of rotation of the convey roller corresponding to the puck 500. FIGS. 6B-6I are schematic diagrams of various example vector fields, combinations of which may be used to guide items in any of various operations.

FIGS. 6B and 6C are schematic diagrams of an example conveyance vector field formed by an example addressable roller module, and of the example addressable roller module, disposed between two conveyor elements, and controlled to align conveyed items along a center of the flow path according to one or more example embodiments. As shown, this vector field may by formed by convey rollers aligned in more than two distinct directions, and the speed of each of multiple directional groupings of elements may be configured to yield the same resultant vector velocity in the conveyance direction.

FIGS. 6D and 6E are schematic diagrams of an example conveyance vector field formed by an example addressable roller module, and of the example addressable roller module, disposed between two conveyor elements, and controlled to align conveyed items along an edge of the flow path according to one or more example embodiments. As shown, this example vector field may include rollers aligned in more than one distinct direction, and the speed of each of multiple directional groupings of elements may be configured to yield a same resultant vector velocity in the conveyance direction.

FIGS. 6F and 6G are schematic diagrams of an example conveyance vector field formed by an example addressable roller module, and of the example addressable roller module, disposed between a first input conveyor element and two output conveyor elements, and controlled to “soft” divert a conveyed item onto a divert output conveyor element according to one or more example embodiments. Small parcels may slide, tumble, and/or lose their tracking when there are abrupt changes in speed or direction. If such parcels are identified prior to the divert, an addressable roller module can be controlled to “soft” divert such parcels by, for example, changing the speed and direction of each row of pucks from 0 degrees to 30 degrees, maintaining the vector speed in a pass through direction, and keeping the vector speed in the pass through direction at least substantially consistent with the conveyor speed when the convey rollers guide the parcels off of the pass through direction. As shown, this example vector field may be formed by convey rollers aligned in more than two distinct directions, and the speed of each of multiple directional groupings of elements may be configured to yield the same resultant vector velocity in the conveyance direction.

FIGS. 6H and 6I are schematic diagrams of an example conveyance vector field formed by an example addressable roller module, and of the example addressable roller module, disposed between a first input conveyor element and two output conveyor elements, and controlled to divert a conveyed item onto a divert output conveyor element according to one or more example embodiments. In a case in which parcels are not pre-aligned to a diverting side of a conveyor, an addressable roller module can increase a divert angle for parcels that are farther away from the discharge. In this example also, the vector speed may be maintained in the pass through direction at least substantially consistent with the conveyor speed. The divert angle may be based on parcel data obtained via a monitor system and a control system as discussed below. Longer parcels may require a more aggressive divert due to the resistance of the parcel that is on a conveyor element (e.g. an induct belt) while the leading edge of the parcel enters the addressable roller module. For example, a divert angle may be increased from 30 degrees to 45 degrees when the parcel length is greater than a length of the addressable roller module perpendicular to the direction of the flow. Wider parcels may require a more aggressive divert due to a limited clearance between the width of the parcel and the width direction of the conveyor element. The leading edge of a wider parcel may be turned more quickly to endure that the parcel makes it onto a discharge conveyor element without colliding with a side of the element, potentially causing jams. For example, a divert angle may be increased from 30 degrees to 45 degrees when the parcel width is greater than 50% of a width of the discharge conveyor element perpendicular to the direction of flow.

### Sortation System

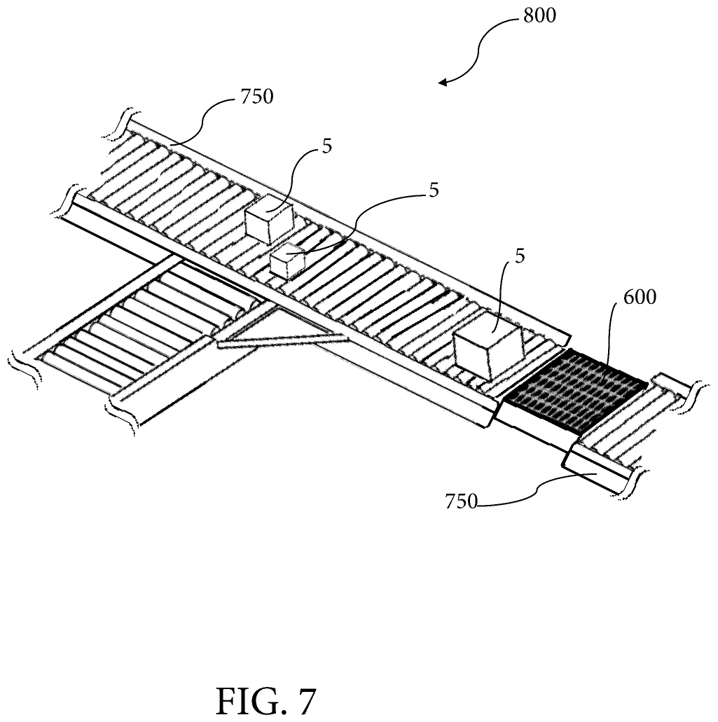

FIG. 7 is a diagram of a sortation system including an addressable roller module according to an example embodiment. According to one or more example embodiments, a sortation system may include any of a variety of different types of conveyors, a plurality of which may be arranged together to form one or more paths for conveying items, where the paths may branch, turn, and/or merge. The system 800 of FIG. 7 includes conveyor elements 750, addressable roller module 600, monitor system 820, and control system 850. The first conveyor element 750 conveys items 5 onto the addressable roller module 600, which in turn, conveys items onto the second conveyor element 750. Of course a sortation system may include any of a variety of simple or complex arrangements and combinations of multiple conveyor elements and addressable roller modules each one or more of which may be controlled by a control system as discussed in greater detail below.

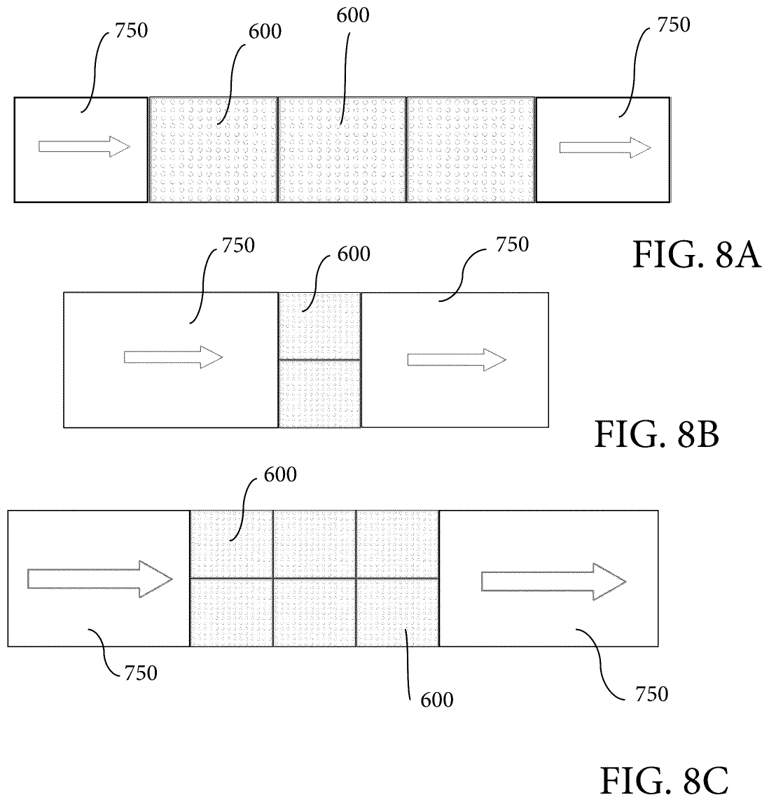

FIGS. 8A-8C are perspective illustrations of different arrangements of multiple addressable roller modules according to one or more example embodiments. FIG. 8A shows three addressable roller modules 600 aligned in a series and disposed between a first conveyor element 750 and a second conveyor element 750. The illustration of three modules in FIG. 8A is merely an example and more or fewer modules may be aligned in a series. FIG. 8B shows two addressable roller modules 600 aligned in parallel and disposed between a first conveyor element 750 and a second conveyor element 750. The illustration of two modules in FIG. 8A is merely an example and more modules may be aligned in a series. FIG. 8C shows an array of six addressable roller modules 600 disposed between a first conveyor 750 and a second conveyor 750. In each of FIGS. 8A-8C, the arrows on the first and second conveyor elements indicate the conveying direction, and in each of FIGS. 8A-8C, there is only a single (first) conveyor element which inputs items to the modules and only a single (second) conveyor element which receives items from the modules; however, these are merely examples, and two or more conveyor elements may input to an arrangement of modules and/or two or more conveyor elements may receive items output from an arrangement of modules.

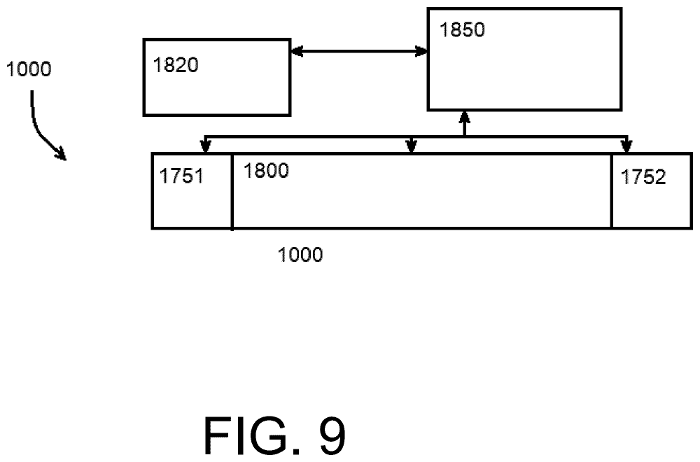

FIG. 9 is a diagram of a sortation system according to another example embodiment. As shown in FIG. 9, a sortation system 1000 may include; an infeed conveyor 1751; an outfeed conveyor 1752; singulation equipment 1800; a monitor system 1820 including, for example, one or more visual sensing devices; and a control system 1850 including, for example a programmable logic controller (PLC).

One or more example implementations of the system 1000 may contribute to achieving the goals of singulation: ensuring that parcels transported within the system are separated by a minimum gap enabling the individual processing of parcels; consistent throughput: maintaining a steady flow of parcels through the system; justification: aligning parcels as desired on various elements of the system; and collision avoidance: simultaneously controlling the velocities of multiple parcels in multiple directions thereby avoiding collisions.

The singulation equipment 1800 may include one or more addressable roller modules according to any one or more example embodiments described herein and arranged in any layout as would be understood by one of skill in the art. As referred to herein, the term “singulation equipment” 1800 may be used interchangeably with the term “singulator” 1800.

According to one or more example embodiments, a sortation system, for example the sortation system 1000 of FIG. 9 or the sortation system 800 of FIG. 7 may include a monitor system configured to image and/or identify items being conveyed, the destination(s) of items, the location(s) of items within the sortation system, the arrangement and positioning of items on a conveyor or other element, and the desired path of items in the system.

The sortation system 1000 of FIG. 9 includes monitor system 1820 including, according to one or more example implementations, one or more sensors, for example, but not limited to visual sensors, configured to obtain real-time information of items such as parcels being transported within the system 1000. An example monitor system may additionally include one or more: barcode readers positioned to read information, for example from barcodes attached to parcels, such as identification data, destination, and desired path of item(s); RFID readers positioned to receive information, for example from RFID tags attached to parcels or to elements of the system itself,; other devices positioned to image parcels at any of various points within the system, photoelectric imaging devices used to identify and track the leading and trailing edges of one or more parcels and/or the positions, sizes, and shapes of gaps between and among parcels. One or more readers and/or imaging devices may be disposed at one or more divert locations, for example, to ensure proper diverting.

Still further elements of a monitor system may include Bluetooth or BLE devices, barcode readers, QR code readers, NFC devices, optical sensors, still and video image capture devices; light detection and ranging (LiDAR) sensors; motion detect sensors; pressure sensors; weight sensors; and any of a variety of other sensors as would be understood by one of skill in the art.

Elements of an example monitor system may be communicatively and operationally connected, either individually or in groups of one or more monitor elements to one or more elements of the sortation system, for example to determine an operational status thereof. Such connections may be via wired or wireless connections either separately to individual elements or to groups of elements. Wireless connections may be, for example, via antennas, Bluetooth or Bluetooth Low Energy (BLE), Near-Field Communication (NFC), or another means, as would be understood by one of skill in the art.

The real time information for each individual parcel may include, but is not limited to: three-dimensional dimensions of the parcel; location of the leading and trailing edges of the parcel; spacing between the parcel and other parcels, edges boundaries, elements, and/or other defined locations within the system 1000; the velocity, acceleration, and trajectory of the parcel; the location of the parcel along a defined path or trajectory; an identity of the parcel, an orientation of the parcel; an alignment of the parcel with respect to other parcels, edges boundaries, elements, and/or other defined locations within the system 1000.

The monitor system 1820 may be communicatively and operationally connected, either individually or in groups to elements of the singulator 1800 to thereby obtain real-time information of each puck of each addressable roller module. The real-time information may include, but is not limited to: the angle of orientation, velocity, and acceleration of each puck; the respective position of each puck relative to other pucks within each module; the respective position of each module relative to other modules within the system; and the operational status of each puck. Alternately, the monitor system may include one or more sensors configured to obtain such information, as would be understood by one of skill in the art.

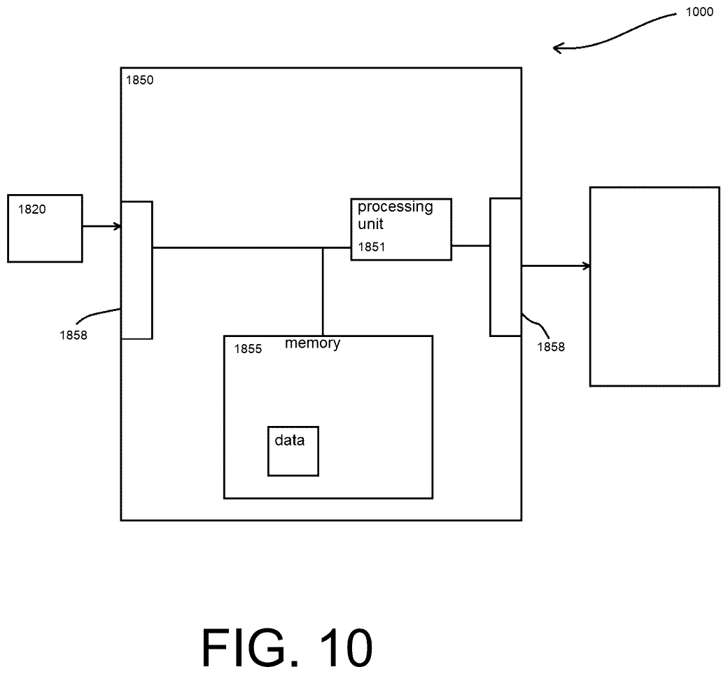

According to one or more example embodiments, a sortation system, for example the sortation system 1000 of FIG. 9 or the sortation system 800 of FIG. 7 may include a control system configured to control one or more elements of the system including, but not limited to, for example, the monitor system, conveyors, such as the infeed conveyor 1751 and outfeed conveyor 1752 of FIG. 9, and singulators, such as the singulator 1800 of FIG. 9. According to one or more example embodiments, a control system 1850 may additionally control any one or more other system elements. FIG. 10 is a diagram of the sortation system of FIG. 9 illustrating additional elements of the control system according to an example embodiment. As shown in FIG. 10, a control system 1850 may be a computer including a processing unit 1851, a system memory 1855, and a system bus (not shown). The system bus provides interconnections among the control system components. The processing unit 1851 can be any of various available processors. Dual microprocessors and other multiprocessor architectures also can be employed as the processing unit 1851.

The system bus can be any of several types of bus structures providing operative connections among the elements of the control system 1850 including, but not limited to, a memory bus or memory controller, a peripheral bus or external bus, and/or a local bus using any of a variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 1855 may include volatile memory and nonvolatile memory. A basic input/output system (BIOS), containing basic routines to transfer information among elements of the control slystem 850, such as during start-up, may be stored in nonvolatile memory. By way of non-limiting example, nonvolatile memory may include read only memory (ROM), programmable ROM (PROM), electrically programmable ROM (EPROM), electrically erasable programmable ROM (EEPROM), flash memory, or nonvolatile random access memory (RAM) (e.g., ferroelectric RAM (FeRAM). Volatile memory may include random access memory (RAM), which may act as an external cache memory. By way of non-limiting example, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), Rambus dynamic RAM, and video random access memory (VRAM).

The control system 1850 may also include removable and/or non-removable, volatile and/or non-volatile computer storage media, for example, a disk storage. A disk storage may include, but is not limited to, a magnetic disk drive, floppy disk drive, tape drive, Jaz drive, Zip drive, LS-100 drive, flash memory card, and a memory stick. Disk storage also may include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices to a system bus, a removable or non-removable interface may be used.

The control system can be implemented, at least in part, in digital electronic circuitry, analog electronic circuitry, or in computer hardware, firmware, software, or a combination thereof. Accordingly, the control system 1850 may be implemented, at least in part as a computer program product such as a computer program, program code or computer instructions tangibly stored in the system memory 855 and executed by the processing unit 1851. The control system may obtain information from the monitor system 820, via one or more input/output units 1858. The information may be stored as data, for example in the memory 1855 in the and, based on the information from the monitor system 1820, the processing unit 1851 may independently control each puck in each of one or more addressable roller modules within the system, also via the one or more input/output units. As discussed above, the one or more input/output units may be communicatively and operationally connected, either individually or in groups to one or more elements of the sortation system and one or more elements of the monitor system, via wired or wireless connection. According to one or more example embodiments, a Of course, as would be understood by one of skill in the art, the control system may alternately be implemented, for example, as a computer program product such as a computer program, program code or computer instructions tangibly embodied in another type of information carrier, or in a machine-readable storage device, for execution by, or to control the operation of, another type of data processing apparatus such as a programmable processor, a computer, multiple computers, or a programmable logic controller (PLC).

A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or other device or on multiple device at one site or distributed across multiple sites and interconnected by a communication network. Also, functional programs, codes, and code segments for accomplishing features described herein can be easily developed by programmers skilled in the art. Operations associated with the example embodiments can be performed by one or more programmable processors executing a computer program, code or instructions to perform functions (e.g., by operating on input data and/or generating an output). Operations can also be performed by, and apparatuses described herein can be implemented as, special purpose logic circuitry, e.g., a field programmable gate array (FPGA) or an application-specific integrated circuit (ASIC), for example.

A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example, semiconductor memory devices, e.g., electrically programmable read-only memory (ROM) (EPROM), electrically erasable programmable ROM (EEPROM), flash memory devices, and data storage disks (e.g., magnetic disks, internal hard disks, or removable disks, magneto-optical disks, and CD-ROM and DVD-ROM disks). The processor and the memory can be supplemented by, or incorporated in special purpose logic circuitry.

Computer-readable non-transitory media includes all types of computer readable media, including magnetic storage media, optical storage media, flash media and solid state storage media. It should be understood that software can be installed in and sold with a central processing unit (CPU) device. Alternately, software can be obtained and loaded into the CPU device, including obtaining the software through physical medium or distribution system, including, for example, from a server owned by the software creator or from a server not owned but used by the software creator. The software can be stored on a server for distribution over the Internet, for example.

### Singulator Control Cycle

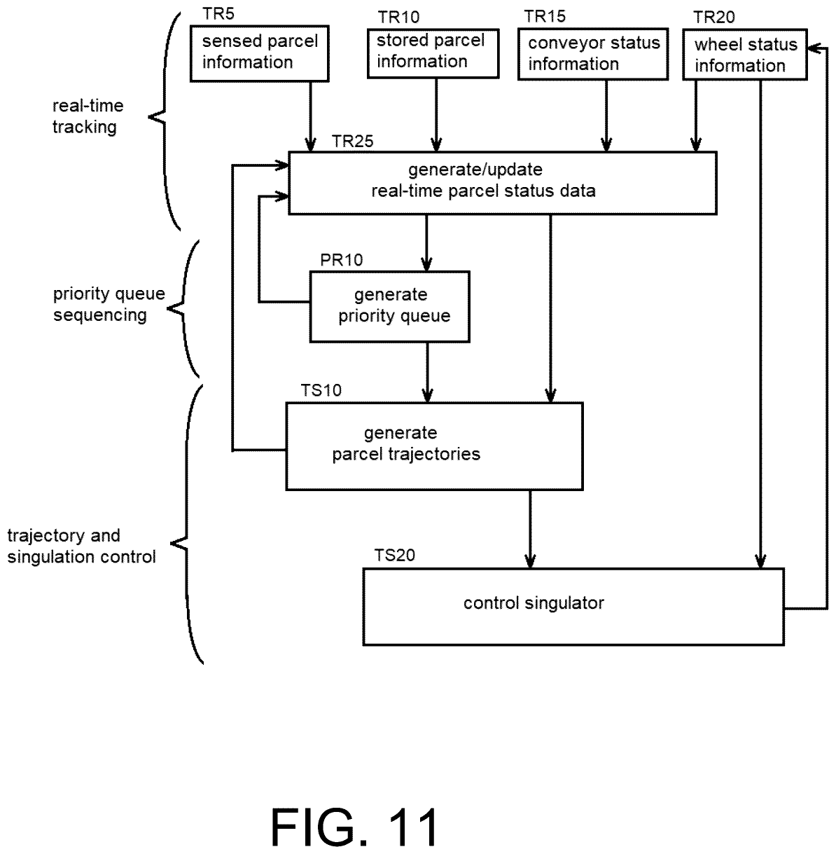

According to one or more example embodiments, a singulator control cycle may be a three-part cycle including real-time tracking, priority queue sequencing, and trajectory and singulation control. The three-part cycle may be continuous and/or iterative. FIG. 11 is a flow diagram of a singulator control cycle according to one or more example embodiments.

### Control Cycle: Real-Time Tracking

An example singulator control cycle as illustrated, for example, in FIG. 11, includes real-time tracking which includes obtaining information including: sensed parcel information (TR5); stored parcel information, for example stored in the memory of the control system (TR10); status information of the infeed and outfeed conveyors, such as the conveyor velocities (TR15); and status information of the elements, for example the wheels, of the singulator (TR20). The sensed parcel information may be real-time information of the parcels obtained from the monitor system detecting and tracking parcels in real-time. For each parcel, the information may include, for example, an identification, dimensions, location of the leading and trailing edges along a flow axis, velocity and acceleration vectors, spacing between the parcel and other parcels, spacing between the parcels and edges boundaries, elements, and/or other defined locations within the system, and orientation. Information corresponding to one or more identified parcels may also be stored and obtained from memory, such as from the control system memory. The status information of the conveyors may be obtained via communication connection with the conveyors themselves or via one or more sensors sensing real-time status information of the conveyors. Likewise status information of the elements, for example the wheels, of the singulator may be obtained via communication connection with the singulator or elements thereof themselves or via one or more sensors sensing real-time status information of the singulator or singulator elements. One or more of the information from TR5, 10, 15, and 20 is used in the generation and updating of real-time parcel status data for each parcel within the sortation system, or, for example, each parcel disposed on the singulator (TR25). The real-time parcel status data may comprise, for each parcel, an identification and status information associated with the parcel identification, where the status information may include, but is not limited to any one or more of location of the leading and trailing edges along a flow axis, velocity and acceleration vectors, spacing between the parcel and other parcels, spacing between the parcel and edges boundaries, elements, and/or other defined locations within the system, orientation, and priority within a priority queue.

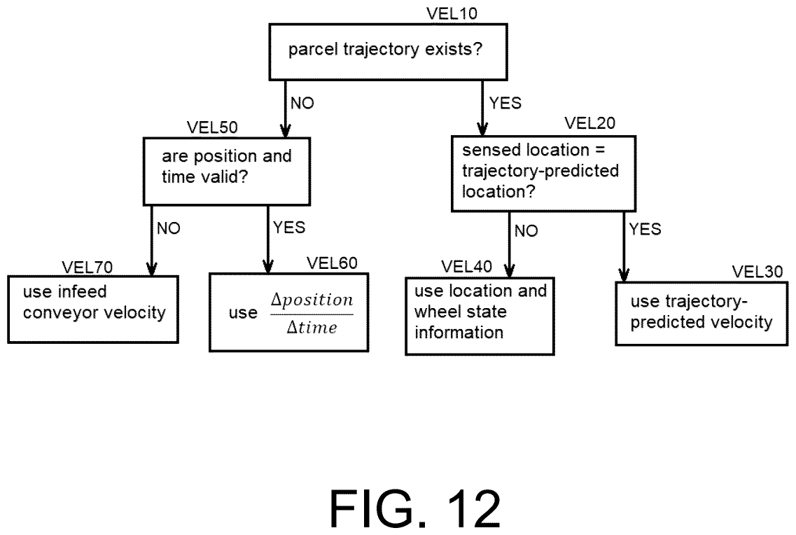

The generation and updating of real-time parcel status data (TR25) may include the determination of velocity information for a parcel. This determination of velocity information for a parcel may be determined in any of various ways based on, for example, any one or a combination of: a velocity of the parcel sensed by the monitor system; location of the parcel sensed by the monitor system and status information of wheel(s) of the singulator corresponding to the parcel location; an existing trajectory of the parcel; a change in location of the parcel over time; and a velocity of the infeed conveyor. FIG. 12 is a flow diagram of an example flow process of a determination of real-time velocity information for a parcel according to one or more example embodiments. As shown in FIG. 12, if a trajectory exists for a parcel (VEL10, YES), then a determination is made as to whether a location of the parcel as sensed by a sensor of the monitor system matches with a location of the parcel predicted by the trajectory (VEL20). If the sensed location is the same as the trajectory-predicted location (VEL20, YES), a trajectory-predicted velocity of the parcel is included in the real-time parcel status information (VEL30). If the sensed location is not the same as the trajectory-predicted location (VEL20, NO), the velocity of the parcel that is included in the real-time parcel status information is calculated based on wheel status information of the wheel(s) of the singulator corresponding to the sensed location of the parcel (VEL40). If there is no trajectory for the parcel (VEL10, NO), then a determination is made as to whether the position information of the parcel and time information are considered to be valid (VEL 50). If the position and time information are considered to be valid (VEL50, YES), the velocity of the parcel that is included in the real-time parcel status information is calculated based on a change in the position of the parcel over time (VEL60). If the position and time information are not considered to be valid (VEL50, NO), the velocity of the infeed conveyor is used as the velocity of the parcel that is included in the real-time parcel status information (VEL70).

The real-time parcel status data generated in the real-time tracking portion of the singulator control cycle (TR25) is updated such that parcel information sensed by sensors of the monitor system, for example, is reconciled with information associated with a parcel previously included the real-time parcel status data. For example, the generation and updating of real-time parcel status data (TR25) may include the determination and updating of position information for a parcel which may be performed using a last timestep velocity according to Equation A, where xₜ is a location of an identified parcel at a time t, xₜ₋₁ is a location of an identified parcel at a previous timestep t−1, vᵢ is a velocity of the identified parcel and Δt is the difference between t and t−1.

$${x}_{t} = {x}_{t - 1} + {v}_{i} cos θΔ t \qquad Equation A$$

According to one or more example implementations, information obtained in one or more of operations TR5, TR10, TR15, and TR20 may be stored in a memory of the controller 1850 and/or may be transmitted from the controller 1850. Likewise, according to one or more example implementations, any of the real-time parcel status data may be stored in a memory of the controller 1850 and/or may be transmitted from the controller 1850.

### Control Cycle: Priority Queue Sequencing

The generated and/or updated real-time parcel status data (TR25) is used to generate a priority sequence of parcels (PR10). The parcels included in the sequence may be, for example, those parcels having been identified as within the sortation system or as on the singulator. Factors that may be taken into account in the prioritization of a parcel in the sequence may include the x-min position of a parcel, i.e. the position of the trailing edge of the parcel along the flow axis, a desired positioning of the parcels in order to prevent collisions, and any one or more of other information included in the real-time parcel status data. Once generated, the priority queue may be fed back into the singulator control cycle and priority queue information may be used to maintain and update the real-time parcel status data (TR25), and this feedback may be performed, for example, continuously at a defined time step.

### Control Cycle: Trajectory and Singulation Control

Trajectory and singulation control includes computing and updating trajectories for parcels based on the priority queue and the real-time parcel status data (TS10), and using the generated trajectories are to dynamically control the speed, direction, power, and orientation/swivel of each roller in each puck of the singulator (TS20). Once generated, the parcel trajectories may be fed back into the singulator control cycle and parcel trajectory information may be used to maintain and update the real-time parcel status data (TR25).

The trajectory for each parcel may comprise a sequence of position and velocity vectors over time, for example at each defined time step, and the position and velocity vectors are used to determine and update the orientation/swivel and velocity of each corresponding wheel of the singulator. The parcel trajectories may be generated using a finite element method in which, at each time step for example, the previous time step's results are used to determine the parcel's location in x and y dimensions, velocity vector, and acceleration vector, and active status.

The parcel trajectories are used to determine the control of each of the elements of the singulator, and as the elements of the singulator are controlled, information of the real-time status of the elements of the singulator is also fed back into the singulator control cycle and may be used to generate and update the real-time parcel status data (TR20, TR25).

A parcel trajectory may include a sequence of position and velocity vectors over time, and the velocity vectors over time may be determined based on whether the parcel is to be in a phase of deceleration/acceleration, justification, and/or rotation.

The control of the singulator (TS20) includes projection of the trajectories of the parcels onto the corresponding wheels of the singulator.

According to one or more example implementations, the control of the singulator (TS20) may additionally include controlling a speed of the infeed and/or outfeed conveyors.

### Example Singulation Operations

Control of the singulator (TS20) in a singulator control cycle, for example the singulator control cycle of FIG. 11, includes one or more singulation operations in which one or more addressable modules are controlled to form dynamically changing conveyance vector fields to control and direct the movement of one or more parcels being conveyed within the sortation system.

According to one or more example embodiments, one or more addressable roller modules may be positioned individually, in series, or in an array, between or among conveyors and other elements of a sortation system in order to perform the one or more singulation operations and/or combinations thereof.

Singulation-Items, for example parcels, in a sortation system may be conveyed in a bulk flow, or a non-organized type of flow in which, for example, a number of items are conveyed in no particular arrangement, not in consistent positions, orientations, and without any consistent pitch between items. Related art sortation technology cannot sort individual items when they are in a bulk flow. Singulation is a process by which items in a bulk flow are moved, shifted, and conveyed in such a manner as to position the items in a manner suitable for individual, automated sortation, such as in a single flow with a uniform pitch or gap. According to an example embodiment, one or more addressable roller module(s), such as, but not limited to, the example module 600, may be arranged individually, in series, or in an array, between conveyor elements in a system to receive a bulk flow of items from a preceding conveyor element, perform sortation thereby arranging the received items into a single flow, and direct the single flow onto a subsequent conveyor element. The module(s) may be controlled to form dynamically changing conveyance vector fields including, for example, those of FIGS. 6B, 6C, 6D, and 6E. Additionally, one module, or multiple modules in parallel may form multiple conveyance vector fields, each controlled to direct the flow of one of many smaller items.

Additionally, according to an example embodiment, the module(s) may be controlled in a “park and go” operation in which one or more items may be directed out of a singulated flow stream and injected back into the flow stream when a suitable window, or gap, is available.

Diversion-Diversion is a process by which the conveyance path of one or more items may be shifted (turned), as, for example, to direct an item from a first conveyor element conveying in a first direction onto another conveyor element conveying in a second, different direction. In another diversion example, an item may be directed from a conveyor element conveying in a first direction to an output. According to an example embodiment, one or more module(s), such as, but not limited to, the example module 600, may be controlled to form dynamically changing conveyance vector fields including, for example those of FIGS. 6F, 6G, 6H, and 6I.

Sortation-Sortation is a process by which items are shifted with respect to each other, for example, moving one or more items faster than other items, directing one or more items to be closer together or farther away from each other, and diverting different items in different directions. According to an example embodiment, one or more module(s), such as but not limited to, the example module 600, may be controlled to form dynamically changing conveyance fields including any of those described herein, and any others, as would be understood by one of skill in the art. Such sortation may be used to create or close a window between items or for controlled merging of items/flows.

Combinations-According to an example embodiment, as would be understood by one of skill in the art based on the descriptions herein,, one or more module(s), such as, but not limited to, the example module 600, may be deployed as individual modules and/or rows, lines, or arrays of modules and may be combined with a monitor system and control system and related art conveyor elements and within a sortation system, thus enabling many different operations including bulk flow input, singulation, alignment, diversion, sortation, and any combinations of these operations.

Example control operations-According to one or more example embodiments, one or more monitor and control systems may be implemented in combination with one or more addressable roller modules such as but not limited to the example module 600, may operate together to track items through the sortation system, measure gaps between products, trigger sortation, trigger error operations, trigger safety operations, determine a distance between an item and a fixed point, modify or trigger operations for dynamic diverting, merging, and/or singulation, acquire item position, orientation, and velocity, and trigger or modify item manipulation operations

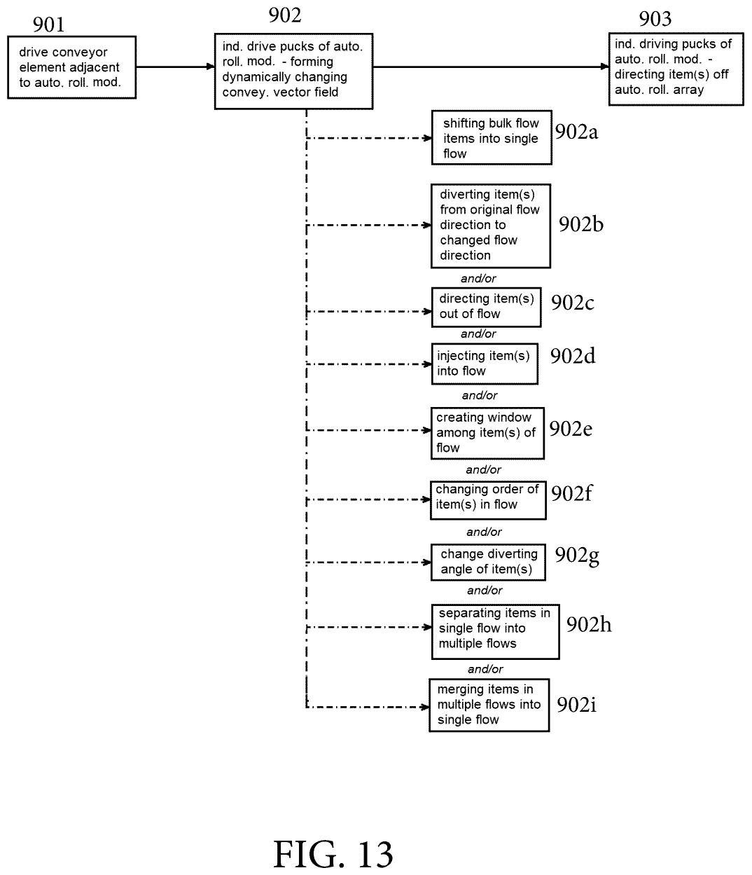

FIG. 13 illustrates a flow of example operations according to one or more example embodiments. According to one or more example embodiments, a flow of example singulation operations may include: driving a first conveyor element (e.g., an infeed conveyor), positioned adjacent to an automated roller module (e.g., a singulator), controlling the conveyor element to direct item(s) onto the automated roller module (901); independently driving each of a plurality of pucks of the automated roller module, thereby forming a dynamically changing conveyance vector field (902); and independently driving pucks of the automated roller module, thereby directing item(s) off the automated roller module (903). The operation 901 may be modified to another method of causing item(s) onto the automated roller module, such as, but not limited to, automatically dumping or placing items from a chute or other location onto the automated roller module. The independently driving each of a plurality of pucks of the automated roller module, thereby forming a dynamically changing conveyance vector field may include any of shifting bulk flow items into a single flow (902a); diverting item(s) from an original flow direction to a changed flow direction (902b); directing item(s) out of a flow (902c); injecting item(s) into a flow (902d); creating a window among item(s) of a flow (902e); changing an order or item(s) in a flow (902f); changing a diverting angle of item(s) (902g); separating items in a single flow into multiple flows (902h); and/or merging items in multiple flows into a single flow (902i). The independently driving each of the plurality of pucks of the automated roller module, thereby forming a dynamically changing conveyance vector field may alternately, additionally, and/or in combination, include any of various other operations of conveying, shifting, or otherwise moving item(s) in the sortation system. The method may further include an operation of receiving data from one or more elements of a monitor system according to one or more example embodiments as discussed herein, and the operations of the method may be performed by a sortation system including a control system as described herein according to one or more example embodiments.

### Singulation Control Phases

According to one or more example embodiments, a singulation system, such as system 1000 including infeed conveyor 1751, outfeed conveyor 1752, singulator 1800, monitor system 1820, and control system 1850, may operate in real-time to perform multiple phases of singulation control including, but not limited to operations of a deceleration/acceleration phase, a justification phase, and a rotation phase.

The monitor system continuously monitors parcels within the system and provides real-time information to the control system. The control system is also continuously provided with information of the real-time status of the conveyors and the singulator, either via communicative and operational connection thereto or via the monitor system. Based on this real-time information, as well as feedback information, the control system may dynamically control the conveyors and singulator, thereby enabling the dynamic optimization of parcel flow through the system by modulating the velocities, spatial alignment, and sequencing of parcels within the system.

The different phases of singulation control, as well as the various operations within each of the phases may be event-triggered, wherein real-time tracking provides information which is monitored to identify when one or more triggers have occurred and thereby initiate one or more of the phases and/or operations.

### Deceleration/Acceleration Phase

According to one or more example embodiments, the singulator may be controlled to perform operations to form dynamically changing conveyance vector fields to modulate the velocity of a parcel to decelerate or accelerate a parcel to, for example, prevent parcel congestion, to increase throughput as, for example, by closing a gap between parcels, or to synchronize the speed of a parcel with another parcel, or with the outfeed conveyor.

In the flow of parcels through the sortation system, it is desirable to maintain a consistent and optimized parcel flow, avoiding parcel collisions, and controlling the singulator such that the parcels entering the outfeed conveyor are substantially aligned along a flow axis of the conveyor and oriented such that a long axis of each parcel is substantially parallel to the flow axis.

One example trigger which may initiate an operation in the deceleration/acceleration phase is detection that a parcel “pitch,” defined as a length of an identified parcel, lengthi, plus a length of the gap between the identified parcel and a downstream parcel, gapi, is too small—i.e. smaller than a desired gap, gapdes. Another example trigger is detection that a length of the gap between the identified parcel and a downstream parcel, gapi, is too small. These triggers may indicate that two or more parcels are too close together near the singulator's end, and may also indicate that the parcel flux out of the singulator is greater than the parcel flux into the singulator. For optimal operation, it may be desirable that a parcel flux out of the singulator is greater than a parcel flux into the singulator. This can be approximated by the parcel length, lengthi, and gap length, gapi, normalized by an area being observed, and may be represented by Equation 1, discussed in greater detail below. Based on the detection of one of these triggers, a deceleration operation may be initiated in which the singulator is controlled to dynamically change conveyance vector fields to decelerate the identified parcel. The initiated deceleration operation may further include decelerating all parcels upstream of the identified parcel until reaching a parcel which has achieved the desired gap, gapdes, with respect to an immediately downstream parcel.

Another example trigger which may initiate an operation in the deceleration/acceleration phase is detection that the length of the gap between the identified parcel and a downstream parcel, gapi, is too large—i.e. larger than the desired gap, gapdes. Other example triggers are detection that an identified parcel is first in the priority queue, identification that the velocity of an identified parcel, vᵢ, is below a desired velocity, v_{des}, where the desired velocity may be the velocity of a downstream parcel, v_{down}, the velocity of the outfeed conveyor, v_{outfeed}, or another velocity as would be understood by one of skill in the art. These triggers may indicate excessive gaps between parcels and/or that parcel throughput may not be optimized. Based on the detection of one of these triggers, an acceleration operation may be initiated in which the singulator is controlled to dynamically change conveyance vector fields to accelerate the identified parcel to reduce the gap, gapi, to the desired gap, gapdes, and/or to increase the velocity of the identified parcel, vᵢ, with the desired velocity v_{des}. Another example trigger which may initiate an operation in the deceleration/acceleration phase is a determination that the gap, gapi, between an identified parcel and a downstream parcel is such that, the desired gap, gap_{des}, will be achieved when the identified parcel is accelerated to a desired velocity, v_{des}. Based on detection of this trigger, an acceleration operation may be initiated to accelerate the identified parcel to the desired velocity, v_{des}.

Equations 1, 2, and 3, discussed below, may be referenced to determine whether a trigger has occurred, and/or in order to determine a particular deceleration/acceleration operation is to be initiated.

Equation 1 may be used, for example, to approximate parcel flux into and out of the singulator where, v_{infeed} is the velocity of the infeed conveyor, v_{outfeed} is the velocity of the outfeed conveyor, length; is the length of an identified parcel, gapᵢ is the gap between the identified parcel and a downstream parcel, and length_{sing} is the length of the singulator measured from a position slightly before the singulator to the end of the singulator.

$${\sum }_{i = 0}^{n} \frac{{v}_{infeed} ( {length}_{i} + {gap}_{i} )}{{length}_{sing}} < {v}_{outfeed} \qquad Equation 1$$

Equation 2 may be used, for example, to evaluate the respective positions of an identified parcel and a downstream parcel defined along a flow axis x where xᵢᵢ is the position of the leading edge of the identified parcel, x_{id} is the position of the trailing edge of the downstream parcel, vᵢ is the velocity of the identified parcel, v_{d} is the velocity of the downstream parcel, v_{des} is a desired velocity, gap_{des} is a desired gap, t_{id} is a time required for the identified parcel to accelerate to the velocity of the downstream parcel, and a is the acceleration of the identified parcel.

$${x}_{td} = {x}_{li} = \frac{( {v}_{d} + {v}_{i} )}{2} {t}_{id} - {v}_{des} {t}_{id} + {gap}_{des} \qquad Equation 2$$

$${t}_{id} = \frac{{v}_{d} - {v}_{i}}{a}$$

Equation 3 may be used, for example, to evaluate the velocity of an identified parcel with respect to the velocity of a downstream parcel and that of the outfeed conveyor where xᵢᵢ is the position of the leading edge of the identified parcel, Xd is the position of the trailing edge of the downstream parcel, vᵢ is the velocity of the identified parcel, v_{d} is the velocity of the downstream parcel, v_{outfeed} the velocity of the outfeed conveyor, gap_{des} is the desired gap, and t_{id} is a time required for the identified parcel to accelerate to the velocity of the downstream parcel.

$${x}_{td} - {x}_{li} = ( \frac{( {v}_{d} + {v}_{i} )}{2} - {v}_{outfeed} ) {t}_{id} + {gap}_{des} \qquad Equation 3$$

Equation 3A may be referenced, for example, in place of Equation 2 and Equation 3, when it is desired to consider a desired final velocity for an identified parcel that is different from a desired final velocity of a downstream parcel, for example, to meet the needs of special parcels. In Equation 3A, xₜₐ is the position of the trailing edge of the downstream parcel, xᵢᵢ is the position of the leading edge of the identified parcel, v_{des-i} is a desired velocity of the identified parcel, v_{des-d} is a desired velocity of the downstream parcel, vᵢ is the velocity of the identified parcel, v_{d} is the velocity of the downstream parcel, ai is an acceleration of the identified parcel, ad is an acceleration of the downstream parcel, and gapᵢ is the gap between the identified parcel and the downstream parcel.

$${x}_{td} - {x}_{li} = \frac{( {v}_{des - i}^{2} - {v}_{i}^{2} - 2 {v}_{des - d} {v}_{des - i} + 2 {v}_{des - d} {v}_{i} )}{2 {a}_{i}} - \frac{( 2 {v}_{des - d} {v}_{d} - {v}_{d}^{2} - {v}_{d}^{2} )}{2 {a}_{d}} + {gap}_{i} \qquad Equation 3 A$$

According to one or more example implementations, the deceleration/acceleration phrase may include operations in which one or more parcels are decelerated or accelerated by increasing or decreasing the velocity of the infeed conveyor. An example trigger which may initiate an operation of changing the velocity of the infeed conveyor is a determination that the parcel flux out of the singulator being less than the parcel flux into the singulator. This may be evaluated based on Equation 1, for example, and determination of this trigger may initiate an operation of decreasing the infeed conveyor velocity v_{infeed}. Another example trigger which may initiate an operation of changing the velocity of the infeed conveyor is a determination that the parcel flux out of the singulator is significantly greater than the parcel flux into the singulator. This may be evaluated based on Equation 1, for example, and determination of this trigger may initiate an operation of increasing the infeed conveyor velocity v_{infeed}.

### Justification Phase

According to one or more example embodiments, the singulator may be controlled to perform operations to form dynamically changing conveyance vector fields to move one or more parcels to shift the one or more parcels onto a justification line which may correspond, for example, to a flow axis, or to a center or a line a predetermined spacing from one of the sides of the outfeed conveyor. This may be accomplished by controlling the singulator to form dynamically changing conveyance vector fields to adjust a direction and magnitude of a velocity vector of each of one or more parcels.

An example trigger which may initiate an operation in the justification phase is a determination that singulation is complete for an identified parcel which may be, for example, a determination that an identified parcel's trailing edge is upstream of the leading edge of any parcel which is behind the identified parcel in the priority queue. Another example trigger may be a determination that a justification operation performed on the identified parcel will not cause a collision. Yet another example trigger may require both that the identified parcel's trailing edge is upstream of the leading edge of any parcel which is behind the identified parcel in the priority queue and that a justification operation performed on the identified parcel will not cause a collision. Based on the occurrence/detection of one or more justification triggers, a justification operation may be initiated in which the singulator is controlled to dynamically change conveyance vector fields to adjust the direction or the direction and magnitude of the identified parcel's velocity vector to move the identified parcel onto the justification line.

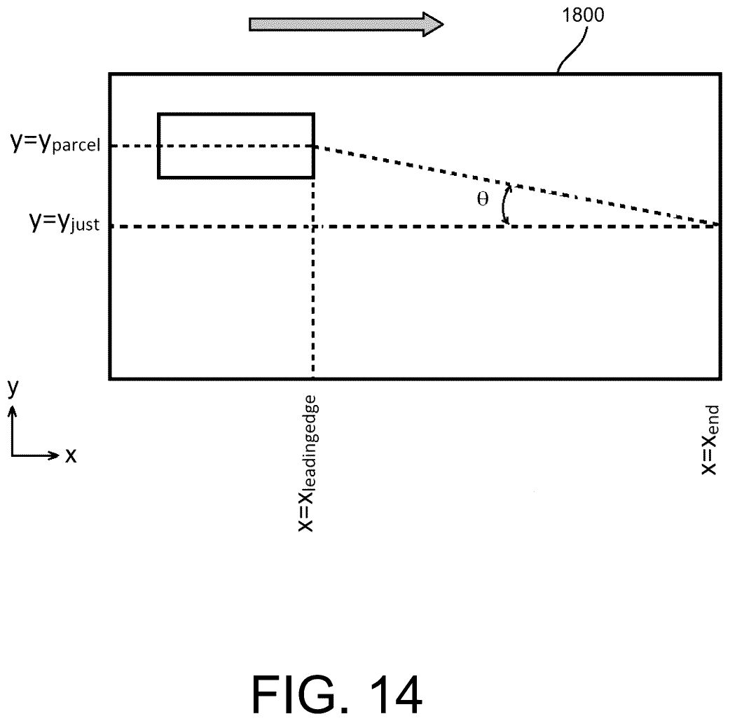

FIG. 14 is an example schematic illustration of a singulator 1800 with an identified parcel disposed thereon and shows that, for purposes of an Equation 4 at least, where the shaded arrow indicates a direction of flow, the x direction is the direction of flow parallel to a flow axis and a justification line; the y direction is perpendicular to the x direction, across a width of the singulator; yⱼᵤₛₜ is the y-coordinate of the justification line; y_{parcel} is the y-coordinate of a center of the identified parcel; x_{end} is the x-coordinate of the end of the singulator, adjacent to the outfeed conveyor; x_{leadingedge} is the x-coordinate of the leading edge of the identified parcel; and 0 is the angle of a velocity vector which should be used to move the identified parcel onto the justification line. Thus, the Equation 4 may be referenced with the aim of adjusting the velocity vector of the identified parcel, where Vx is the velocity of the identified parcel; and V is the velocity vector.

$$θ = {tan}^{- 1} \frac{{y}_{just} - {y}_{parcel}}{{x}_{end} - {x}_{leadingedge}} \qquad Equation 4$$

$$V = \frac{{V}_{x}}{cos θ}$$

Completion of the justification phase with respect to an identified parcel may be confirmed when it is determined, for example, that the identified parcel is aligned with the justification line.

### Rotation Phase

According to one or more example embodiments, the singulator may be controlled to perform rotation operations to form dynamically changing conveyance vector fields to contribute to aligning a long edge of each of one or more parcels with the flow axis. This may be accomplished by controlling the singulator to form dynamically changing conveyance vector fields to rotate each of the one or more parcels such that an angle β between a long edge of the parcel and the flow axis is decreased to substantially zero.

An example trigger which may initiate an operation in the rotation phase is a determination that the justification phase for the identified parcel is complete. Other example triggers may be that rotation of the identified parcel will not cause a collision; and that rotation will not reduce the throughput of the singulator. Yet another example trigger may require both a determination that the justification phase is complete and that a rotation of the identified parcel will not cause a collision. Finally, an example trigger may be a combination of two or more other triggers. Based on the occurrence/detection of one or more rotation triggers, a rotation operation may be initiated in which the singulator is controlled to dynamically change conveyance vector fields to rotate the identified parcel.

Completion of the rotation phase with respect to an identified parcel may be confirmed when it is determined, for example, that the long axis of the identified parcel is parallel to the flow axis.

While aspects and implementation of example embodiments have been shown and described herein, it will be understood by those skilled in the art that various changes in form and details may be made therein. For example, various communication protocols can be deployed with various electronic sensors, and/or various visual and/or audio user interfaces can be implemented to facilitate processing and/or displaying information and/or controlling hardware and/or software components of the system.

It may be understood that example embodiments described herein may be considered in a descriptive sense only and not for purposes of limitation. Descriptions of features, aspects, or implementations within each example embodiment may be considered as available for other similar features, aspects, or implementations in other example embodiments.

Furthermore, example embodiments described herein may be implemented in conjunction with any of various individual components and methodologies, as well as any of various combinations of components and methodologies described, for example, in any of: U.S. Pat. No. 11,731,169; U.S. Published Patent Application Pub. No. 2023-0159281; and/or U.S. patent application Ser. No. 18/419,410, filed Jan. 22, 2024. The disclosures of U.S. Pat. No. 11,731,169; U.S. Published Patent Application Pub. No. 2023-0159281; and/or U.S. patent application Ser. No. 18/419,410, are incorporated herein by reference in their entireties.

While example embodiments have been and described with reference to the figures, it will be understood by those skilled in the art that various changes in form and details may be made therein without departing from the spirit and scope as defined by the following claims.

We claim:

1. An automated singulation method of a sortation system comprising a monitor system, comprising at least one sensor, and a singulator comprising an array of a plurality of independently-addressable rollers; the method comprising:
the at least one sensor sensing real-time information of each of a plurality of parcels within the sortation system;
generating real-time parcel status data comprising, for each of the plurality of parcels, a parcel identification and status information;
ordering a priority queue in which each of the plurality of parcels is assigned a relative priority, based on the real-time parcel status data;
for each of the plurality of parcels, determining a parcel trajectory based on the real-time parcel status data and the priority queue; and
dynamically controlling the independently-addressable rollers of the singulator to form dynamically changing conveyance vector fields thereby enabling the independently-addressable rollers to guide each of the plurality of parcels along a correspondingly-generated parcel trajectory;
wherein:
the method comprises performing the sensing, generating, ordering, determining, and dynamically controlling in a repeated plurality of cycles.

2. The method according to claim 1 wherein, in a given cycle of the plurality of cycles, the real-time parcel status data is generated based on the real-time information of each of the plurality of parcels, the priority queue ordered in a cycle prior to the given cycle, and one or more of the parcel trajectories determined in a cycle prior to the given cycle.

3. The method according to claim 2, wherein the generating the real-time parcel status data comprises determining a parcel velocity for each of the plurality of parcels, wherein the determining the parcel velocity comprises:
determining that a trajectory-predicted velocity is the parcel velocity when a trajectory is determined for the parcel and a sensed location of the parcel is the same as a trajectory-predicted location of the parcel;
determining the parcel velocity based on the sensed location of the parcel and status information of rollers corresponding to the sensed location of the parcel when a trajectory is determined for the parcel and the sensed location of the parcel is not the same as the trajectory-predicted location of the parcel; and
determining the parcel velocity based on a change in the sensed location of the parcel over time when there is no trajectory determined for the parcel and the sensed position of the parcel is valid.
